(19) United States
(12) Patent Application Publication
(10) Pub. No.: US 2012/0318998 A1
(43) Pub. Date: Dec. 20, 2012

(54) ON-LINE MEASUREMENT METHOD FOR IONIZING RADIATION

(76) Inventors: Vladimir Kondrasovs, Palaiseau (FR); Romain Coulon, Chaulgnes (FR); Stephane Normand, Isigny Le Buat (FR)

(21) Appl. No.: 13/579,016

(22) PCT Filed: Feb. 15, 2011
(86) PCT No.: PCT/EP11/52170

§ 371 Date: Aug. 14, 2012

(30) Foreign Application Priority Data
Feb. 17, 2010 (FR) 10 51110

(51) Int. Cl. G01T 1/02

(52) U.S. Cl. 250/395; 250/336.1

(57) ABSTRACT

A smoothing method associated with the on-line measurement of a signal output by an ionizing radiation detector comprising the following steps: detect pulses contained in successive samples of said signal, count the numbers Nᵢ of pulses detected, apply non-destructive filtering to said signal using a variable detection threshold, and apply adaptive smoothing to the filtered signal using non-linear processing as a function of the state of change of said signal so as to obtain a smoothed count rate for said pulses.

### TECHNICAL FIELD

The invention is in the field of on-line detection of weak fluctuations in the flux of radioactive radiation among statistically caused fluctuations. It is more specifically related to a smoothing method associated with on-line measurement of a signal output by an ionising radiation detector comprising the following steps:

detect pulses contained in successive samples of said signal,

count the number of pulses Nᵢ detected for each sample.

The invention also relates to a device for on-line measurement of an ionising radiation signal comprising:

a radioactive radiation detector,

an electronic module conditioning detected radioactive radiation signals,

a module to count pulses contained in successive samples of the detected signal.

### STATE OF PRIOR ART

Known detectors used in industry and operating in count mode give an estimate of the count rate by simple integration with an integration constant adjusted as a function of the measured system and physical parameters intrinsic to the sensor. Other variants of this method are commonly used, for example such as sliding integration, in which the signal is integrated with a constant integration constant for a constant time step, thus facilitating adjustment of the integration constant and giving an average in time. An omission factor (for example exponential) may also be applied to weight each event degressively as a function of the delay, so as to artificially improve the statistical precision without losing any sensitivity.

These methods are very destructive and archaic compared with the possibilities available with microcontroller type onboard calculation features. Therefore, sophisticated methods have been developed in order to perform more adaptive signal processing as a function of random variations of the inter-pulse space. However, the latter methods do not take account of the stochastic nature of the nuclear signal.

According to these approaches, the signal is considered to fluctuate only slightly with time. This is physically not the case because the measurement at time T has no influence on what the measurement will be at time T+1, insofar as the signal can vary considerably from one sampling instant to the next.

Other sophisticated statistical signal processing methods based on a Bayesian approach solved by Monte Carlo methods using Markov chains are also known. These are very iterative and cannot be used without high calculation power which makes it difficult to use them in a nuclear detector.

One purpose of the invention is a smoothing method and a smoother that could be associated with an onboard microcontroller computer, that could introduce non-linearity relative to the integrations method and that could take account of the stochastic nature of the nuclear signal with a calculation time appropriate for real time constraints of the onboard electronics.

### PRESENTATION OF THE INVENTION

This purpose is achieved using a smoothing method associated with the on-line measurement of a signal output by an ionising radiation detector comprising the following steps:

detecting pulses representing successive samples of said signal,

counting the number Nᵢ of pulses detected.

The method according to the invention comprises the following steps:

applying non-destructive filtering to said signal using a variable detection threshold,

applying adaptive smoothing to the filtered signal using non-linear processing as a function of the state of change of said signal so as to obtain a smoothed count rate for said pulses.

This method enables detection of small variations in the radioactivity despite high statistical noise intrinsic to the nuclear measurement.

In one preferred embodiment, the method according to the invention also comprises the following steps:

for a sample Eᵢ of the detected signal, use a primary stack to store the numbers Nᵢ₊ₘ of pulses counted during an elementary time Δt where m varies from 1 to N_{M}, N_{M} representing the number of values that can be contained in said primary stack, and,

store cumulated sums of numbers Nᵢ₊ₘ, in a secondary stack normalised by the acquisition time, such that said secondary stack contains mean values Sⱼ obtained by convergence of a series of estimated values.

Preferably, for j=1 at N_{M} where N_{M} represents the quantity of saved values and M is the primary stack memory size, the mean values S_{k+NM} are calculated using the following equation I:

$${S}_{j} = \frac{{\sum }_{m = 1}^{m = {a}_{j}} {N}_{i + m}}{{a}_{j} Δ t} \qquad ( I )$$

aⱼ represents the filling series of the secondary stacks.

Note that the filling series a of the secondary stacks is not necessarily constant. A constant function induces a credibility weight between two consecutive different positions in terms of a compromise between gain/loss of statistical precision and gain/loss of time precision.

Furthermore, building a non-linear discretisation scale in time can be more rigorous considering the Poisson nature of the signal and can increase the smoothing potential (the maximum integration range becoming much larger). A time sampling function is proposed as follows:

Consider the signal sample Eᵢ estimated by the different values Sⱼ of the secondary stack, such that:

$${S}_{j} = \frac{{\sum }_{m = 1}^{m = {a}_{j}} {N}_{i + m}}{{a}_{j} Δ t} \qquad ( 1 )$$

Nᵢ₊ₘ: Number of events counted in position m in the primary stack.

Δt: The primary stack time step.

The standard deviation associated with signal Sᵢ is defined in equation 2.

$$σ ( {S}_{j} ) = \sqrt{\frac{{S}_{j}}{{a}_{j} Δ t}} \qquad ( 2 )$$

Let α be the ratio of the gain in statistical precision between two positions relative to the loss of time information:

$$\frac{Δ ( σ ( {S}_{j} ) )}{{a}_{j} Δ t} = α \qquad ( 3 )$$

Δσ(Sᵢ): Difference in precision on the value S between positions j and j−1.

The solution of the equation (3) in a continuous space gives the value of α:

$$α = - \frac{\sqrt{S}}{2} {( {a}_{j} Δ t )}^{- 3 / 2} \qquad ( 4 )$$

The value of the time step finally obtained is presented in the following equation (5):

$${a}_{j} = - ⌈ 2 Δ ( \frac{σ ( {S}_{i} )}{S} ) \sqrt{S Δ t} {a}_{j - 1}^{3 / 2} ⌉ + {a}_{j - 1} \qquad ( 5 )$$

According to one variant embodiment, the method according to the invention comprises the following steps:

scan the secondary stack from k=1 to k=N_{M} to detect a radioactivity variation, and,

at each iteration k, compare the variation ΔSₖ=|Sₖ−Sₖ₊₁| with a detection threshold SDₖ corresponding to the lowest value of the variation of the signal detected allowing for the probabilities α and β, where α represents the risk of incorrect detection and β represents a risk of failure to detect a change in radioactivity.

In this variant, the detection threshold SDₖ is a function of the cumulated Poisson standard deviation of values Sₖ and Sₖ₊₁ represented by the following equation II:

$$\{ \begin{matrix}{σ}^{2} ( {S}_{k} ) = \frac{{S}_{k}}{{a}_{k} Δ t} \\ {σ}^{2} ( {S}_{k + 1} ) = \frac{{S}_{k + 1}}{{a}_{k + 1} Δ t} \\ {SD}_{k} \approx Q \sqrt{{σ}^{2} ( {S}_{k} ) + {σ}^{2} ( {S}_{k + 1} )}\end{matrix} \qquad ( II )$$

where Q is a coverage factor conditioning smoothing of the signal dependent on the probabilities α and β as described in the following equations III:

$$\{ \begin{matrix}β + α = 1 \\ β \approx \frac{1}{\sqrt{2 π}} {\int }_{- Q}^{∞} {e}^{- {x}^{2} / 2} d x\end{matrix} \qquad ( III )$$

The method according to the invention is implemented by an on-line measurement device for an ionising radiation signal comprising:

a radioactive radiation detector,

an electronic conditioning module for detected radioactive radiation signals,

a pulse count module representing successive samples of a detected signal, characterised in that said count module comprises:

a non-destructive filter using a variable detection threshold,

an adaptive smoother using non-linear processing as a function of the state of variation of said signal so as to obtain a smoothed count rate of said pulses.

This device also comprises:

a primary stack in which the number Nᵢ of pulses counted on a sample Eᵢ of the detected signal during an elementary time Δt, will be stored, where i varies from 1 to N_{M}, where N_{M} represents the number of values that said primary stack can contain,

a secondary stack in which the cumulated sum of numbers Nᵢ normalised by the acquisition time for each sample Eᵢ will be stored, such that said secondary stack contains the mean values S_{k+NM} obtained by convergence of a series of estimated values Sⱼ for the signal sample Eᵢ.

### BRIEF DESCRIPTION OF THE DRAWINGS

Other characteristics and advantages of the invention will become clear from the following description given as a non-limitative example with reference to the appended figures in which:

FIG. 1 diagrammatically shows an on-line measurement system of an ionising radiation signal according to the invention,

FIG. 2 diagrammatically shows a filling procedure for a primary stack in the system in FIG. 1,

FIG. 3 diagrammatically shows a filling procedure for a secondary stack in the system in FIG. 1,

FIG. 4 contains a flowchart illustrating the smoothing step in the method according to the invention,

FIG. 5 shows curves illustrating the variation of detection/non-detection risks as a function of a coverage factor Q conditioning the operating mode of a smoother in the system in FIG. 1,

FIG. 6 shows operating ranges of the smoother of the system in FIG. 1 as a function of the coverage factor Q,

FIG. 7 diagrammatically shows the response of the smoother in the system in FIG. 1 to one step.

### DETAILED PRESENTATION OF PARTICULAR EMBODIMENTS

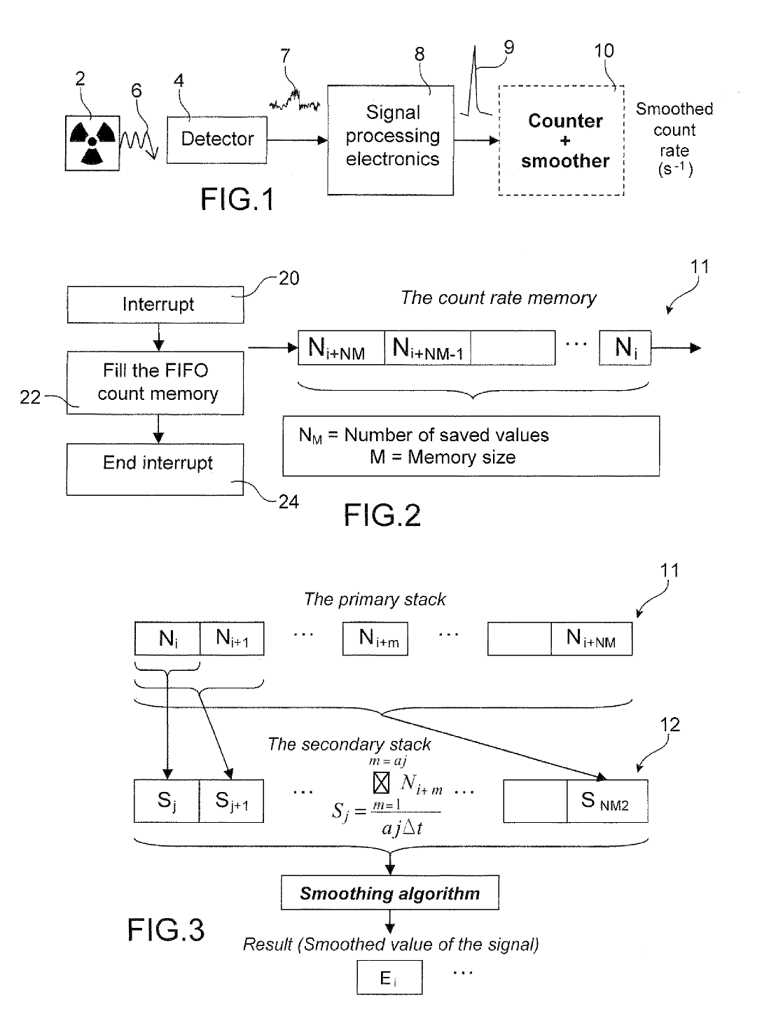

FIG. 1 shows a device for online measurement of the radioactivity of a radioactive system 2 that varies in time. This device comprises a detector 4 that receives a radioactive radiation signal 6 produced by a radioactive system 2 and outputs samples Eᵢ 7 of the detected signal to an electronic module 8. The electronic module 8 filters and amplifies pulses Iᵢ 9 contained in the successive samples Eᵢ 11 and outputs amplified and filtered pulses to a count module 10.

The count module 10 comprises a non-destructive filter using a variable detection threshold, an adaptive smoother using non-linear processing as a function of the state of change of said signal so as to obtain a smoothed count rate of said pulses, a primary FIFO (First In, First Out) type stack 11 that can contain N_{M} numeric values representative of the pulse count rate, and a secondary stack 12 that will contain the cumulated sum of the number of pulses

$${\sum }_{m = 1}^{m = {a}_{j}} {N}_{i + m}$$

counted during an elementary time Δt.

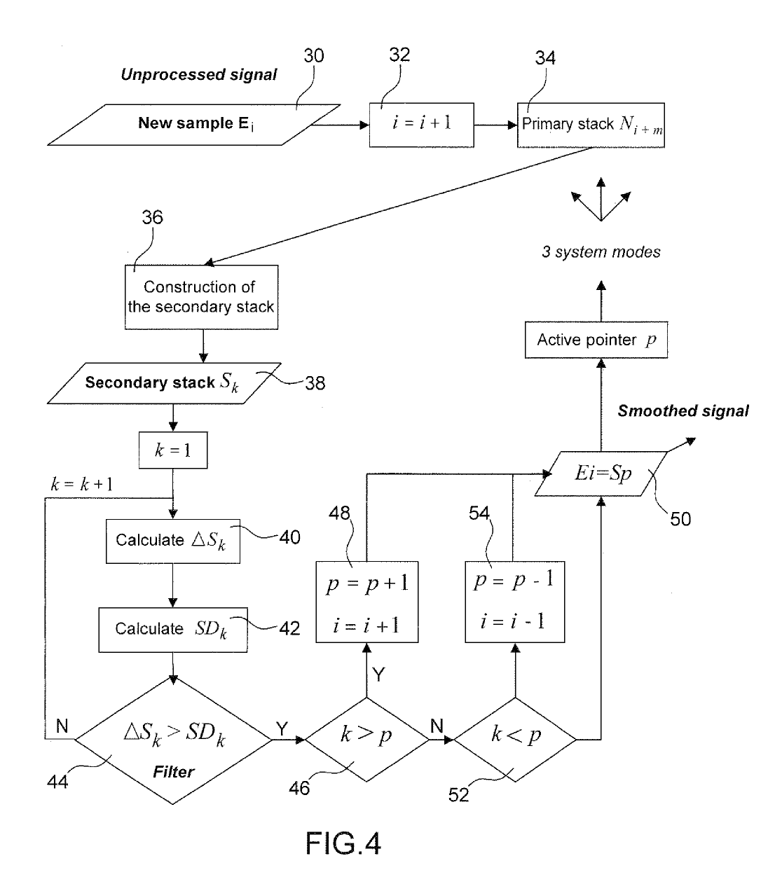

The method according to the invention is characterised by the adaptability of the smoother to the variation of the signal by using an active pointer p to very finely smooth activity transients in agreement with real time constraints. The processing time is accelerated during the constant activity phases and slowed during transient activity phases. During each processing, the position pointed to in the secondary stack 12 is shifted towards the direction of the change in activity as will be described later in detail with reference to FIG. 4.

During operation the smoother receives a flow of pulses and outputs the number of counted pulses Nᵢ₊ₘ during an elementary time Δt to the primary stack. The filling procedure of the primary stack 11 is shown in FIG. 2.

With reference to this FIG. 2, detection is interrupted in step 20.

In step 22, the smoother outputs the number of pulses counted Nᵢ during an elementary time Δt to the primary stack.

Detection is resumed in step 24.

As shown in FIG. 3, the smoother makes the cumulated sum of successive numbers of pulses Nᵢ, Nᵢ₊₁, . . . , N_{i+NM} for each sample Eᵢ of the detected radioactivity signal, and it outputs a smoothed value of the count rate normalised by the acquisition time to the secondary stack 12.

The secondary stack 12 then contains a series Sⱼ of estimated values for the signal sample Eᵢ. This series converges from the value Sⱼ corresponding to the unprocessed signal which is correct but not very precise to a highly averaged value S_{NM2}.

The filter chooses a value in this series to improve the precision while guaranteeing accuracy of the measurement.

Note that the filter used to detect a variation in radioactivity is constructed based on the intrinsic characteristics of the nuclear signal. This signal is stochastic in nature such that when the measured radioactivity is stable, the occurrence time of the events strictly follows a Poisson distribution, in other words the signal variance is equal to its mean. Signal fluctuations may be smoothed by integration regarding this condition. When the activity changes, this condition is no longer respected, and the signal must no longer be integrated.

FIG. 4 shows a flow chart illustrating the smoothing step in the method according to the invention.

Step 30 shows detection of a new sample Eᵢ of a radioactive signal by the detector 4.

In step 32, the number N_{1+N}_{_{M}} of pulses corresponding to the unprocessed signal of Eᵢ, is counted and then stored in the primary stack 11 (step 34).

Step 36 consists of creating the secondary stack 12 by entering the cumulated sum of successive numbers Nᵢ₊ₘ for sample Eᵢ stored in the primary stack.

In step 38, the cumulated sum is calculated and then stored in the secondary stack 12.

To detect a variation in the radioactivity, the secondary stack 12 is scanned and the variation ΔSₖ=|Sₖ−Sₖ₊₁| is calculated (step 40) for each iteration k of the cumulated sum Sₖ, and the detection threshold SDₖ corresponding to the smallest expected value of the signal variation that can be systematically declared to have been detected within probabilities α and β is then calculated in step 42. The α risk is a first order risk corresponding to the risk of an incorrect detection, and the β risk is a second order risk corresponding to the risk of failure to detect a change in radioactivity.

In step 44, the variation ΔSₖ=|Sₖ−Sₖ₊₁| is compared with the threshold SDₖ.

This detection threshold is a function of the cumulated Poisson standard deviation of the values Sₖ and Sₖ₊₁ shown in equation II:

$$\{ \begin{matrix}{σ}^{2} ( {S}_{k} ) = \frac{{S}_{k}}{{a}_{k} Δ t} \\ {σ}^{2} ( {S}_{k + 1} ) = \frac{{S}_{k + 1}}{{a}_{k + 1} Δ t} \\ {SD}_{k} \approx Q \sqrt{{σ}^{2} ( {S}_{k} ) + {σ}^{2} ( {S}_{k + 1} )}\end{matrix} \qquad ( II )$$

The coverage factor Q conditions the operating mode of the smoother. It depends on the probabilities α and β as shown in equation III:

$$\{ \begin{matrix}β + α = 1 \\ β \approx \frac{1}{\sqrt{2 π}} {\int }_{- Q}^{∞} {e}^{- {x}^{2} / 2} d x\end{matrix} \qquad ( III )$$

In step 46, the position k pointed to in the secondary stack 12 is compared with the active pointer p (memory of the position obtained for the previous sample).

If k>p, the active pointer p and the position of the sample Eᵢ recorded in the primary stack 11 are incremented by one unit (p=p+1) and (i=i+1) (step 48).

In this case, the response sent (step 50) is the value of the signal at the location defined by the pointer in the secondary stack 12.

The operation is repeated until the detection point is located before the active pointer (k<p) (step 52). In this case, the active pointer p and the position of the sample Eᵢ recorded in the primary stack 11 are decremented by one unit (p=p−1) and (i=i−1) (step 54).

The response is then estimated in two iterations which can refine smoothing of activity transients while assuring signal processing in real time.

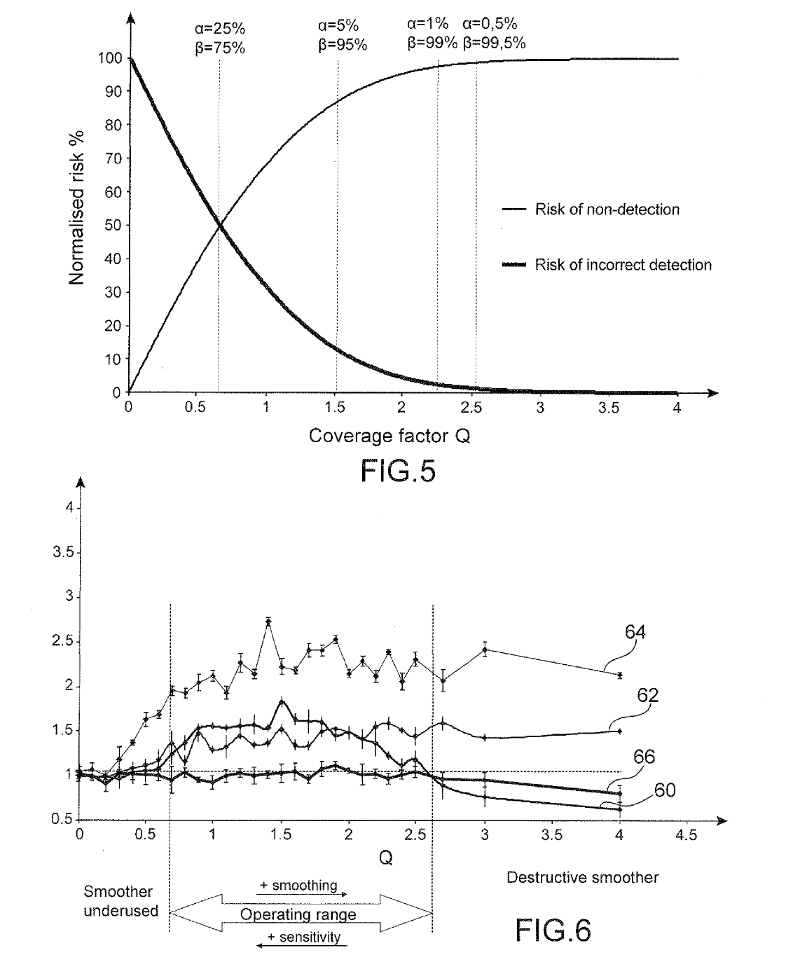

FIG. 5 shows the variation of the probabilities α and β normalised as a function of the coverage factor Q.

This FIG. 5 shows that the filter is balanced for the value Q=0.67. A lower value will increase the risk of an incorrect detection relative to the risk of non-detection; the smoother is practically inactive. A higher value will reduce the sensitivity of the filter but smoothing is increased. The risk of incorrect detection becomes negligible starting from Q=2.6.

A higher value increases smoothing but the filter performances reduce.

FIG. 6 shows the efficiency of the smoother in terms of the gain in accuracy for four simulated signals with different amplitudes, namely a signal with little noise 60, a noisy signal 62, a very noisy signal 64, and a signal with very little noise 64.

This FIG. 6 shows that the smoother efficiently removes noise from the signal when the coverage factor of the filter is within the operating range between Q=0.67 and Q=2.6.

The curve 66 shows the advantage of the smoother at high count rates. When the count rate is high, the smoother does nothing since by definition, the statistical noise is very low. This curve highlights the destructive effect of oversmoothing when Q>2.6.

For low count rates, the smoother provides a significant gain of precision. The optimum efficiency is achieved within the range 0.67>Q>2.6, and depends on the count rate and radioactivity gradients. Four operating modes can be defined:
Q=0.67: The filter is very sensitive and smoothing is gentle. The least change in radioactivity is almost systematically detected.
Q=1.6: Smoothing is medium. This value is a good compromise, the accuracy and precision provided by the smoother are significant with a minimum degradation of weak radioactivity gradients.
Q=2.6: Smoothing is strong. An optimum gain is provided on the signal precision, however the filter is less sensitive at low radioactivity gradients.
Q>2.6: Smoothing is destructive. An alarm mode can be made with a probability of false alerts equal to α. (example for Q>3.3, α=0.1%).

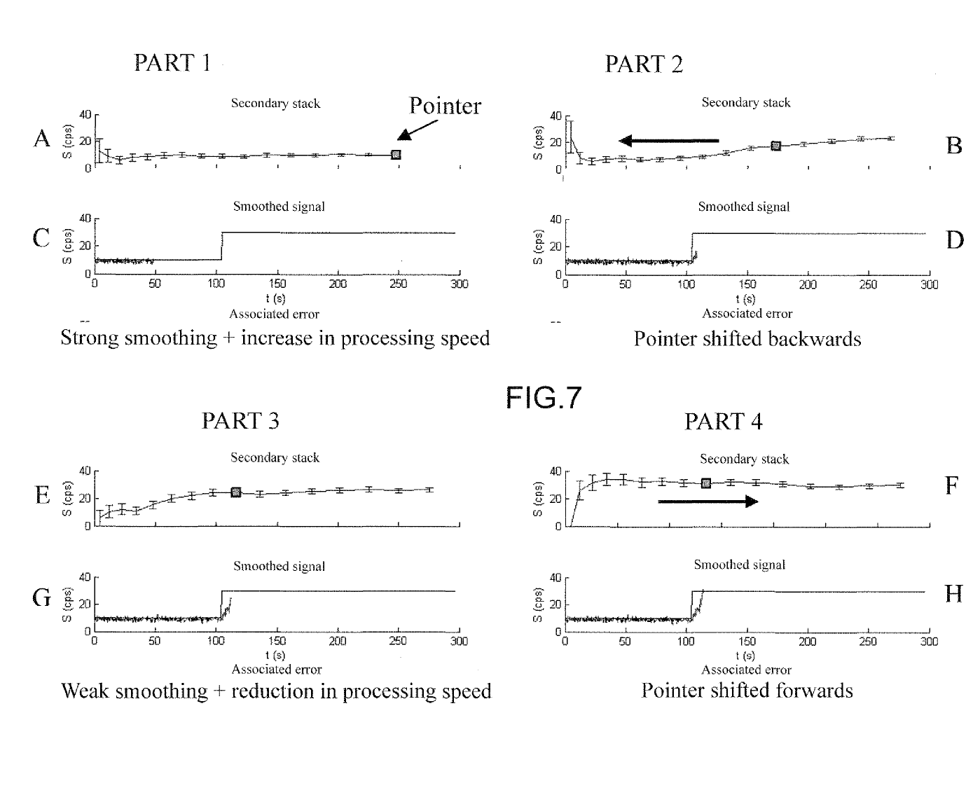

FIG. 7 diagrammatically shows the response of the smoother to a step.

On the part in FIG. 7, when the smoother processes a signal that it considers is constant in terms of criteria α and β as shown in FIG. 7C, the pointer is naturally placed on the position in the secondary stack that gives maximum smoothing as shown in FIG. 7A.

On part 2, as soon as the signal variation is recorded in the counter memory and if the filter detects this significant variation in a position in the secondary stack placed before the position pointed to previously, as shown in FIG. 7B, it can be seen that the pointer shifts back by one position. As shown in FIG. 7D, the smoother will reduce the strength of smoothing to optimally follow the change in the signal (loss of statistical precision/gain in precision with time).

With reference to part 3 in FIG. 7, two iterations are performed for a sample Eᵢ saved in the primary stack when the pointer shifts backwards. As long as the signal variation is detected ahead of the position of the pointer, the pointer continues to shift backwards until it reaches a position with very little smoothing as shown in 7E at which the past signal is forgotten, as shown in FIG. 7G.

Then with reference to part 4 of FIG. 7, the filter no longer detects the signal variation in the secondary stack. The pointer then shifts towards more smoothed positions recorded in the secondary stack as shown in FIG. 7F. When the pointer moves forwards, one sample Eᵢ out of two is processed. The saving in terms of statistical precision allows fast convergence to the new value of the signal as shown in FIG. 7H.

1. Smoothing method associated with the on-line measurement of a signal output by an ionizing radiation detector comprising the following steps:
detecting pulses contained in successive samples of said signal Eᵢ,
counting the number Nᵢ of pulses detected,
method characterized in that it also comprises the following steps:
applying non-destructive filtering to said signal using a variable detection threshold,
applying adaptive smoothing to the filtered signal using non-linear processing as a function of the state of change of said signal so as to obtain a smoothed count rate for said pulses.

2. Method according to claim 1, also comprising the following steps:
for a sample Eᵢ of the detected signal, use a primary stack to store the numbers Nᵢ₊ₘ of pulses counted during an elementary time Δt where m varies from 1 to N_{M}, where N_{M} represents the number of values that can be contained in said primary stack, and,
store the cumulated sum of numbers Nᵢ₊ₘ, in a secondary stack (12), normalized by the acquisition time aⱼΔt, such that said secondary stack (12) contains a mean value S_{NM2} obtained by convergence of a series of estimated values Sⱼ for the signal sample Eᵢ.

3. Method according to claim 2, in which, for j=1 at N_{M2}, the mean values Sⱼ are calculated using the following equation:
$${S}_{j} = \frac{{\sum }_{m = 1}^{m = {a}_{j}} {N}_{i + m}}{{a}_{j} Δ t}$$

4. Method according to claim 1, also comprising the following steps:
scan the secondary stack to detect a radioactivity variation, and,
at each iteration k, compare the variation ΔSₖ=|Sₖ−Sₖ₊₁| with a detection threshold SDₖ corresponding to the lowest value of the variation of the signal detected allowing for the probabilities α and β, α representing a risk of incorrect detection and β representing a risk of failure to detect a change in radioactivity.

5. Method according to claim 2, in which the detection threshold SDₖ is a function of the cumulated Poisson standard deviation of values Sₖ and Sₖ₊₁ represented by the following equations:
$$\{ \begin{matrix}{σ}^{2} ( {S}_{k} ) = \frac{{S}_{k}}{{a}_{k} Δ t} \\ {σ}^{2} ( {S}_{k + 1} ) = \frac{{S}_{k + 1}}{{a}_{k + 1} Δ t} \\ {SD}_{k} \approx Q \sqrt{{σ}^{2} ( {S}_{k} ) + {σ}^{2} ( {S}_{k + 1} )}\end{matrix}$$
where Q is a coverage factor conditioning smoothing of the signal dependent on the probabilities α and β according to the following equations:
$$\{ \begin{matrix}β + α = 1 \\ β \approx \frac{1}{\sqrt{2 π}} {\int }_{- Q}^{∞} {e}^{- {x}^{2} / 2} d x\end{matrix}$$

6. On-line measurement device for an ionizing radiation signal comprising:
a radioactive radiation detector,
an electronic conditioning module for detected signals,
a count module for pulses contained in successive samples of said detected signal, device characterized in that said count module comprises:
a non-destructive filter using a variable detection threshold,
an adaptive smoother using non-linear processing as a function of the state of variation of said signal so as to obtain a smoothed count rate of said pulses.

7. Device according to claim 6 also comprising:
a primary stack in which the numbers Nᵢ₊ₘ of pulses counted on a sample Eᵢ of the detected signal during an elementary time Δt will be stored, where I varies from 1 to N_{M}, where N_{M} represents the number of values that said primary stack can contain,
a secondary stack in which the cumulated sums of numbers Nᵢ normalized by the acquisition time for each sample Eᵢ will be stored, such that said secondary stack contains a mean value S_{NM2} obtained by convergence of a series of estimated values Sⱼ for the signal sample Eᵢ.
